(19) United States
(12) Patent Application Publication
(10) Pub. No.: US 2003/0009341 A1
(43) Pub. Date: Jan. 9, 2003

(54) Humanistic devices and methods for same

(76) Inventors: Tien-Yao Cheng, Taipei (TW); Hen-Te Liao, Sunsha City (TW)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/898,054

(22) Filed: Jul. 5, 2001

(51) Int. Cl. G10L 21/00; G10L 11/00

(52) U.S. Cl. 704/275; 704/270

(57) ABSTRACT

An interactive method and apparatus for communicating with a device. The apparatus is operable in a plurality of modes, including a monitor mode, an instruction mode, a reminder mode, and an emergency mode. In the monitor mode of operation, the apparatus monitors and communicates data signals of a device to a designated recipient. In the instruction mode, the apparatus receives a user request and executes an instruction in response to the user request. In the reminder mode, the apparatus receives a message and automatically communicates to a user a reminder relating to the message. In the emergency mode, the apparatus detects abnormal conditions and communicates the presence of the abnormal conditions to the designated recipient. These modes are operable either alone or in combination.

### BACKGROUND OF THE INVENTION

1. Field of the Invention

This invention relates generally to a method and apparatus for communicating with a device, and more specifically to a method and apparatus designed to detect abnormal conditions relating to voice intonations, speech and/or emotions of a user and abnormal conditions relating to the operation of the device, and to communicate both the normal conditions and the abnormal conditions to a designated recipient.

2. Related Art

In current configurations, a device, such as a medical device, provides a user with assistance in monitoring, diagnosing, or recording the user's condition. In such configurations, however, the user's interaction with the device is limited because the device is inanimate.

It is therefore an object of the present invention to make an inanimate device, such as a medical device, more human-like by processing commands, such as audible commands, and conversing with a user in a humanistic manner.

It is also an object of the present invention to provide a system for monitoring the conditions of a user or a device and to detect emergency conditions related to the user or device, to a designated recipient.

### SUMMARY OF THE INVENTION

In accordance with the invention, there is provided an apparatus that is operable in at least one of a plurality of operating modes. The apparatus includes a recognition engine, a system memory, and a processor.

In one embodiment of the invention, the processor is programmed to receive data signals of a device and transmit the data signals to a designated recipient, when the apparatus is in a first operating mode. The processor is also programmed to receive a user's command, transmit the command to the recognition engine for interpretation of the command, receive the interpreted command from the recognition engine, scan the system memory for a response responsive to the interpreted command, and transmit the response to the user, when the apparatus is in a second operating mode.

There is also provided another embodiment of the invention, where the processor is programmed to receive data signals of a device and transmit the data signals to a designated recipient, when the apparatus is in a first operating mode. In this embodiment, the processor is also programmed to receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

In a preferred arrangement of this embodiment, the processor is further programmed to transmit the reminder at a specified time.

In another preferred arrangement, the processor is further programmed to transmit the reminder upon reaching a specified condition.

There is provided yet another embodiment of the present invention. In this embodiment, the processor is programmed to receive a user's command, transmit the command to the recognition engine for interpretation of the command, receive the interpreted command from the recognition engine, scan the system memory for a response responsive to the interpreted command, and transmit the response to the user, when the apparatus is in a first operating mode. Also in this embodiment, the processor is programmed to receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

In a preferred arrangement of this embodiment, the processor is further programmed to transmit the reminder at a specified time.

In another preferred arrangement, the processor is further programmed to transmit the reminder upon reaching a specified condition.

There is provided still another embodiment of the present invention. In this embodiment, the processor is programmed to receive data signals of a device and transmit the data signals to a designated recipient, when the apparatus is in a first operating mode. In addition, the processor is programmed to receive a user's command, transmit the command to the recognition engine for interpretation of the command, receive the interpreted command from the recognition engine, scan the system memory for a response responsive to the interpreted command, and transmit the response to the user, when the apparatus is in a second operating mode. Next, the processor is further programmed to receive a request for a reminder, transmit the request to the recognition engine for interpretation of the request, receive the interpreted request from the recognition engine, store the interpreted request in the system memory, and transmit the reminder corresponding to the request, when the apparatus is in a third operating mode. Finally, in this embodiment, the processor is also programmed to detect abnormal conditions and communicate the presence of the abnormal conditions to a designated recipient, when the apparatus is in a fourth operating mode.

In a preferred arrangement of this embodiment, the processor is further programmed to generate a constant representing normal conditions, when the apparatus is in the first, second, and third operating modes.

In yet another preferred arrangement of this embodiment, the processor detects the abnormal conditions by comparing the constant representing normal conditions to data signals of the device.

In still another preferred arrangement, the processor detects the abnormal conditions by comparing data signals of the device to a pre-determined condition.

There is also provided another embodiment of the present invention. In the apparatus of this embodiment, the processor is programmed to receive data signals of a device and transmit the data signals to a designated recipient, when the apparatus is in a first operating mode. The processor is further programmed to receive a command of a user, transmit the command to the recognition engine for interpretation of the command, receive the interpreted command from the recognition engine, scan the system memory for a response responsive to the interpreted command, and transmit the response to the user, when the apparatus is in a second operating mode. Finally, in this embodiment, the processor is further programmed to receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

There is also provided a method for communicating with a device in a system, where the system is operable in a plurality of operating modes. When the system is in a first operating mode, the method includes the steps of receiving data signals of the device and transmitting the data signals to a designated recipient. When the system is in a second operating mode, the method includes the steps of receiving a command of a user, transmitting the command to a recognition engine for interpretation of the command, receiving the interpreted command from the recognition engine, scanning a system memory for a response responsive to the interpreted command, and transmitting the response to the user. In a second operating mode, the method includes the steps of receiving a request for a reminder, transmitting the request to the recognition engine for interpretation of the request, receiving the interpreted request from the recognition engine, storing the interpreted request in the system memory, and transmitting the reminder corresponding to the request, when the system is in a third operating mode. When the system is in a fourth operating mode, the method includes the steps of detecting abnormal conditions and communicating the presence of the abnormal conditions to a designated recipient.

Also provided is a system operable in at least one of a plurality of operating modes. The system receives data signals of the device and transmits the data signals to a designated recipient, when the system is in a first operating mode. In a second operating mode, the system receives a user's command, transmits the command to a recognition engine for interpretation of the command, receives the interpreted command from the recognition engine, scans a system memory for a response responsive to the interpreted command, and transmits the response to the user. In a third operating mode, the system receives a request for a reminder, transmits the request to the recognition engine for interpretation of the request, receives the interpreted request from the recognition engine, stores the interpreted request in the system memory, and transmits the reminder corresponding to the request. When the system is in a fourth operating mode, the system detects abnormal conditions and communicates the presence of the abnormal conditions to a designated recipient.

Other systems, methods, features and advantages of the invention will become apparent to one skilled in the art upon examination of the following figures and detailed description. It is intended that all such additional systems, methods, features, and advantages be included within this description, be within the scope of the invention, and be protected by the accompanying claims.

### DESCRIPTION OF THE DRAWINGS

FIG. 1 is a block diagram of a computer system that provides the operating environment for an illustrative embodiment of the present invention.

FIG. 2 is one embodiment of the present invention.

FIG. 3 is a block diagram of a system embodying one embodiment of the present invention.

FIG. 4 is another block diagram of a system embodying one embodiment of the present invention.

FIG. 5 is a flowchart illustrating the monitor mode of operation.

FIG. 6 is a flowchart illustrating the instruction mode of operation.

FIGS. 7A-7B, collectively described as FIG. 7, are flowcharts illustrating the reminder mode of operation.

FIGS. 8A-8B, collectively described as FIG. 8, are flowcharts illustrating the generation and storage of a constant.

FIGS. 9A-9B, collectively described as FIG. 9, are flowcharts illustrating the emergency mode of operation.

### DETAILED DESCRIPTION OF THE PREFERRED EMBODIMENTS

The present invention makes an inanimate device, such as a medical device, more human-like by processing commands, such as audible or touch-tone commands, and by conversing with a user in a humanistic manner. Specifically, the invention includes an apparatus that may detect and recognize voice intonations, speech patterns, and/or emotions of a user and the operating conditions of a device. The apparatus may have a communications element that conveys abnormal conditions relating to the voice, speech, facial expressions, and/or emotions to a designated recipient. The apparatus may also detect and recognize the conditions relating to the operation of a device, and may convey the recognized conditions to a designated recipient. The apparatus may be connected to any type of device, including medical devices, personal digital assistants, cellular phones, or any other type of device that would be beneficial if it could converse with a user in a humanistic manner. Other examples of devices that may be used with the invention include a computer with a modem and a telephone.

The invention may have four alternative modes of operation. These modes include a monitor mode, an instruction mode, a reminder mode, and an emergency mode. The apparatus may be built to include each of these modes either alone or in combination. For example, one apparatus may be built to include the monitor mode and the instruction mode, while another apparatus may be built to include all four modes of operation.

In the monitor mode, a device is connected to the apparatus, while the apparatus monitors the device and communicates the monitored information to a designated recipient. This mode is best illustrated by describing the connection of the apparatus to a medical device. Any type of medical device can be used, including a device that measures blood pressure level, a glucose meter, or a home pregnancy test. Using a glucose meter as an example, the apparatus is connected to the glucose meter, which measures the blood glucose level of the patient. The measurements are transmitted to the apparatus. The apparatus of the present invention may have a communications element such as a modem, a universal serial bus (USB) connection, or an infrared connection that could be linked to a designated recipient at a hospital, a doctor's office, or an insurance company. The apparatus is configured to transmit the measurements to the designated recipient via the communications element. In this way, the designated recipient, such as a hospital, would have access to the patient's measurements and could monitor the patient's progress without the patient having to go to the hospital for an office visit.

The communications element may be a speaker or an LCD display. In this way, the designated recipient, such as the patient or the nurse, may receive the patient's measurements audibly and/or visually.

Also in the monitor mode, the apparatus may generate a constant that represents the normal operation of the device. This constant is stored in the system memory and may be used in the emergency mode of operation to detect abnormal conditions of the device.

In the second mode, which is the instruction mode, user requests may be implemented by use of a speech recognition engine and the system memory that are resident in the circuitry of the apparatus. In the present invention, a speech recognition engine and a voice recognition engine are distinguishable. A speech recognition engine analyzes an acoustic speech signal so as to identify the linguistic message that was intended, so that a machine can correctly respond to spoken commands. A voice recognition engine identifies particular speech patterns, which may be useful in identifying a particular speaker. The present invention may use a speech recognition engine and/or a voice recognition engine.

Using a medical device to illustrate the instruction mode, the speech recognition engine would recognize a user request related to the medical device and appropriately respond to the request. The request may include a command or instruction or a question or query. For example, a first-time user of a glucose meter may have a question regarding the operation of the glucose meter. The user might ask, “How do I measure my blood sugar level?” The apparatus, which is coupled to the glucose meter, would process the query, and retrieve the appropriate instruction from the memory of the apparatus. The apparatus would then provide a response such as a visual or an audible response for the user.

Also in the instruction mode, the apparatus may generate a constant that represents the normal operation of the device and a constant that represents the normal voice intonation, speech, or emotions of a user. A voice recognition engine may be used to generate the constant relating to voice intonation, speech, and/or emotions. These constants may be stored in the system memory and used in the emergency mode of operation to detect abnormal conditions.

Similar to the instruction mode, the reminder mode may use a speech recognition engine and system memory. One of the purposes of the reminder mode is to automatically provide reminders to a user according to either the user's or another's specified instructions. For example, a diabetic patient using a glucose meter might want to receive a reminder about his caloric intake, blood sugar level, medicinal intake, the time to take his medicine, the amount of medication to take, or the type of medicine to take. In the present invention, these and many other reminders may be provided to the user. For example, the user may say, “Remind me to take my medicine at 8:00 p.m. today.” Using the speech recognition engine and system memory, the apparatus processes the user's command or query and stores the reminder message in the system memory. The apparatus retrieves the reminder from the system memory and transmits the reminder to the user at the requested time.

By way of further example, a user may want a reminder regarding his caloric intake. The user may say, “Remind me when my caloric intake exceeds 1200 calories.” In this example, the apparatus would be operable in both the reminder mode and the monitor mode. That is to say, in the monitor mode, the apparatus monitors the device providing the caloric intake, and when the user's intake exceeds 1200 calories, the apparatus transmits a reminder to the user, alerting him that he has exceeded his caloric intake.

In the reminder mode, the present invention can also record doctor's instructions, nurse's reminders, and the encouraging words of friends or family members. The reminder is stored in the system memory, and the apparatus retrieves the reminder and transmits it to the user at a specified time. In this way, a user who is progressing through his successive readouts from the medical device may receive automatic words of encouragement or congratulations to improve and continue following the medical instructions.

The reminder mode may also use a voice recognition engine. In the present invention, the apparatus may maintain a constant representing the user's normal voice intonation, speech, and/or emotions in the system memory. That is to say, the apparatus may generate a constant that represents the user's normal voice and/or emotions. More specifically, the user may speak into a microphone that is coupled to the apparatus. The audible analog signal may then be converted to a digital signal, that is then processed by a microprocessor. The digital signal may then be transmitted to the voice recognition engine, which associates the digital signal with a specific voice intonation, speech pattern, and/or emotion. The voice recognition engine then may generate a constant that is the basis of the user's normal voice intonation, speech and/or emotion. Next, the constant may be transmitted to the microprocessor, and further transmitted to and stored in the system memory.

In the reminder mode, the apparatus also may generate a constant that represents the normal operation of the device. This constant may be used in the emergency mode of operation to detect abnormal conditions.

In the emergency mode of operation, the apparatus of the present invention may detect the presence of an emergency situation, and respond appropriately. First, in normal modes of operation—that is, in the monitor mode, instruction mode, or reminder mode, the apparatus may generate a constant that represents the normal conditions of the device attached to the apparatus. The apparatus may use this constant in the emergency mode. Other means of generating a normal condition constant may be apparent to one skilled in the art. To illustrate, consider a user having a pacemaker attached to his heart. According to the present invention, if the apparatus is coupled to the pacemaker, the apparatus may generate a constant representing the normal operations the pacemaker and the normal conditions of the user. The constant might include the normal speed of the pacemaker, the user's normal heartbeat or rate of heartbeat, or the normal sound of the user's heartbeat. The apparatus may maintain the constant in its system memory. When the user has a medical complication, such as when the pacemaker begins to fail, the apparatus recognizes the abnormal conditions of the pacemaker or the user. Then via the communication function in the apparatus, such as an infrared, satellite or USB connection, the apparatus can transmit a signal to a designated recipient, such as a doctor's office, a hospital, or a 911 emergency service. In this way, the user could get the necessary help before even recognizing the first signs of discomfort.

By way of further example, a cellular phone could be used with the present invention in the emergency mode of operation. It should be noted that any device used in the present invention, including a cellular phone, does not have to be on for the apparatus to be operable. During normal usage of the phone, the apparatus of the present invention may store a constant representing the normal usage conditions of the user, such as voice intonation, speech patterns, and/or emotions. When an emergency develops, the apparatus of the present invention may detect a change in a user's voice intonation, speech, and/or emotion and transmit a signal to a designated recipient, such as an emergency service or a police station, to summon help for the user. For instance, consider a woman who uses a cellular phone. The apparatus may store a constant representing the woman's normal voice intonation, speech pattern, and/or emotions in its system memory during repeated usage by the woman. If the woman faces an emergency situation, she may signal for help by yelling, or making repeated groans or repeated utterances of certain words like “help” or “no.” Regardless of whether the cellular phone is on or not, the apparatus may recognize that the woman's voice intonation, speech pattern, and/or emotion deviates from the constant, and transmit a signal, via either the communications element in the apparatus or the phone service via the cellular phone, to the emergency service or police station. Additionally, the cellular phone may be equipped with a global positioning system (GPS) so that those staffed at the emergency service or police station could immediately identify the woman's location and provide her with the necessary assistance.

By way of even further example, the apparatus of the present invention in the emergency mode of operation might be useful to elderly users of a medical device that is connected to the apparatus. The apparatus may detect conditions such as incoherence of the user, a user's request for help, or the trailing off of the user's voice. The apparatus may recognize that the user's voice intonation, speech pattern, and/or emotion deviates from the constant representing normal conditions, and automatically summon help from a hospital or the police.

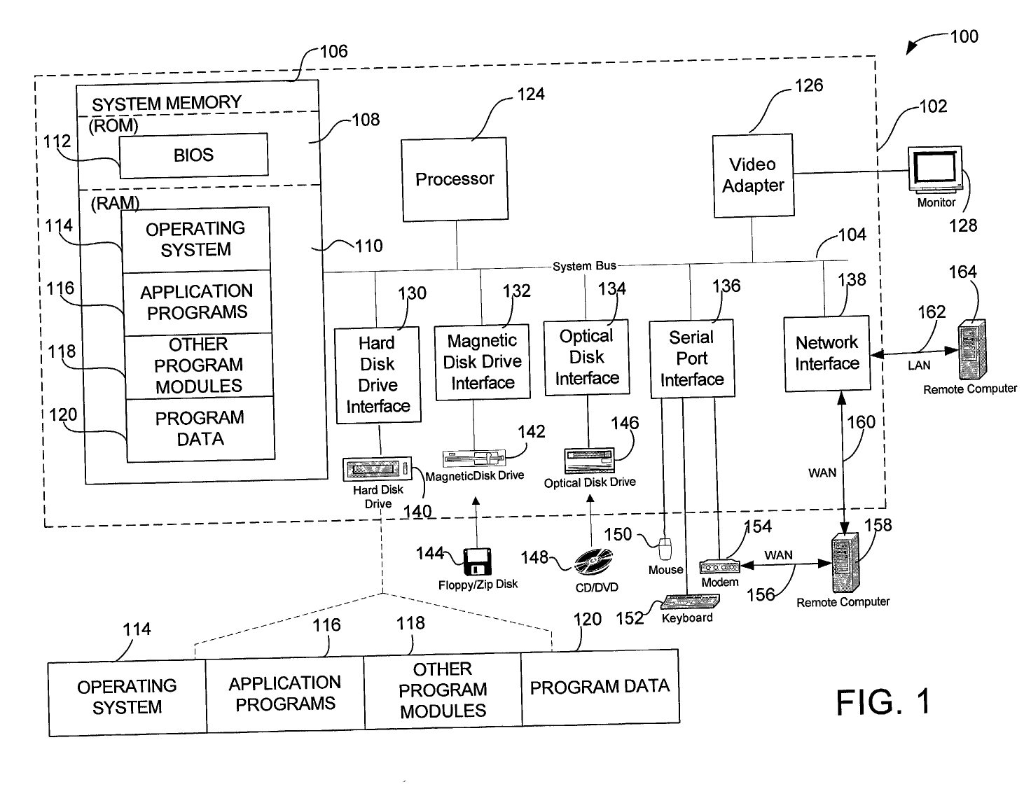

Turning now to the figures, FIG. 1 and the following discussion are intended to provide a brief, general description of a suitable computing environment in which the invention may be implemented. While the invention will first be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distribution computing environments where tasks are performed by remote processing devices that are linked through a communications network. In a distributed computing environment, program modules may be located in both local and remote memory storage devices.

With reference to FIG. 1, an illustrative system for implementing the invention includes a conventional personal computer 102, including a processor 124, a system memory 106, and a system bus 104. The system bus 104 couples the system memory to the processor 124. The system memory 106 includes read only memory (ROM) 108 and random access memory (RAM) 110. A basic input/output system 112 (BIOS), containing the basic routines that help to transfer information between elements within the personal computer 102, such as during start-up, is stored in ROM 108. The personal computer 102 further includes a local hard disk drive 140, a magnetic disk drive 142, for reading from or writing to a removable disk, and an optical disk drive 146, for reading a CD-ROM disk 146, or for reading from or writing to other optical media. The hard disk drive 140, the magnetic disk drive 142, and the optical disk drive 146 are connected to the system bus 104 by a hard disk drive interface 130, a magnetic disk drive interface 132, and an optical disk drive interface 134, respectively. The drives and their associated computer-readable media provide nonvolatile storage for the personal computer 102. Although the description of computer-readable media above refers to a hard disk, a removable magnetic disk, and a CD-ROM disk, those skilled in the art will appreciate that other types of media which are readable by a computer, such as magnetic cassettes, flash memory cards, digital video disks, Bernoulli cartridges, and the like may also be used in the illustrative operating environment of FIG. 1.

A number of program modules may be stored in the drives and RAM 110, including an operating system 114, one or more application programs 116 (e.g., word processor applications, spreadsheet applications, and presentation applications), other program modules 118 (e.g., a speech recognition engine and/or a voice recognition engine), and program data 120. The program data 120 on local hard disk drive 140 may constitute speech data used in connection with the speech recognition engine and/or the voice recognition engine.

A user of computer 102 may enter commands and information into the personal computer 102 through a keyboard 152, and a pointing device, such as a mouse 150. Other input devices (not shown) may include a microphone, joystick, satellite dish, scanner, or the like. These and other input devices are often connected to the processor 124 through a serial port interface 136 that is coupled to the system bus, but may be connected by other interfaces, such as a game port, a microphone input, or a universal serial bus (USB). A monitor 128 or other type of display device is also connected to the system bus 104 via an interface, such as a video adapter 126. In addition to the monitor, personal computers typically include other peripheral output devices (not shown), such as speakers or printers.

The personal computer may operate in a networked environment using logical connections to one or more remote computers, such as remote computers 158 and 164. The remote computers 158 and 164 may be servers, routers, peer devices, or other common network nodes, and the remote computers 158 and 164 typically include many or all of the elements described relative to the personal computer 102. The logical connections to computers 158 and 164 depicted in FIG. 1 include a local area network (LAN) 162 and wide area networks (WAN) 156 and 160. Such networking environments are commonplace in offices, enterprise-wide computer networks, intranets, and the Internet.

When used in a LAN networking environment, the personal computer 102 is connected to the LAN 162 through a network interface 138. When used in a WAN networking environment, the personal computer 102 typically includes a modem 154 or other means for establishing communications over the WAN. The modem 154, which may be internal or external, is connected to the system bus 104 via the serial port interface 136. A WAN connection may also be made through the network interface 138 to WAN 156. In a networked environment, program modules depicted relative to the personal computer 102, or portions thereof, may be stored in the remote memory storage device. Particularly, each remote computer 158 and 164 and their respective storage devices (not shown) can be searchable information repositories. Those of ordinary skill in the art will appreciate that the network connections shown are illustrative, and other means of establishing a communications link between the computers may be used.

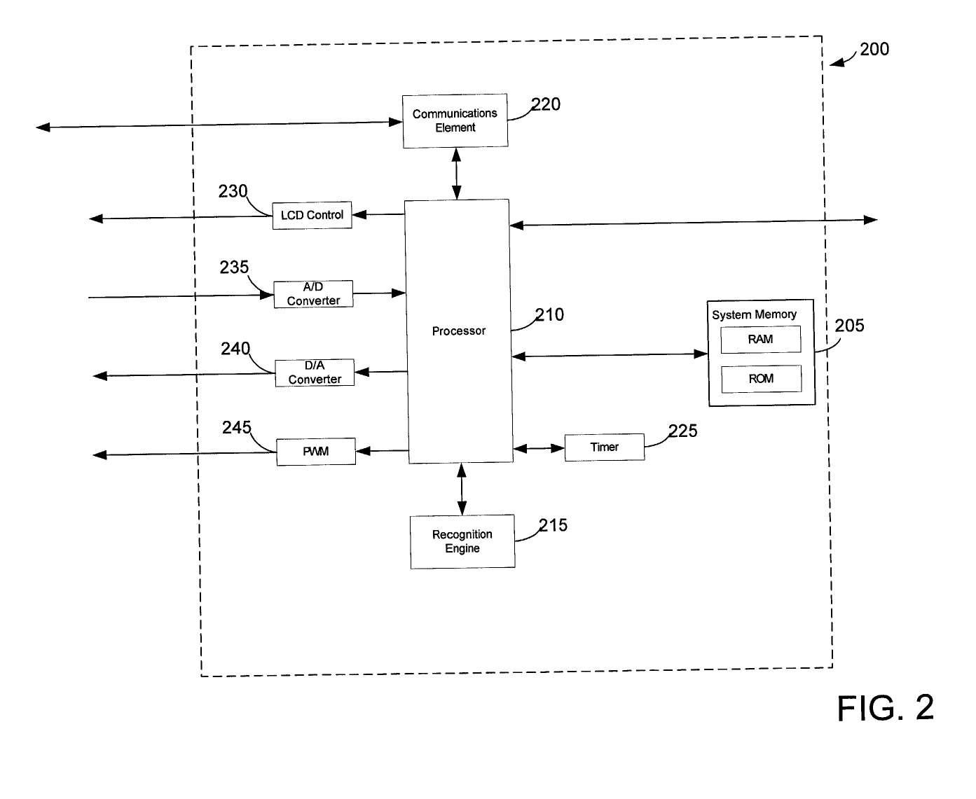

FIG. 2 shows a more specific and detailed block diagram of an embodiment of the present invention, illustrating the circuitry of the apparatus 200. While the description of FIG. 1 was in the context of an application program running on an operating system in conjunction with a personal computer 102, a preferred embodiment of the invention will next be described in the context of an apparatus 200. As shown in FIG. 2, the apparatus 200 includes a processor 210 that is coupled to: system memory 205; a recognition engine 215 (including speech recognition, voice recognition or other type of recognition capabilities); a communications element 220; a timer 225; an LCD control 230; an analog-to-digital converter 235; a digital-to-analog converter 240; and a pulse width modulator 245. The processor 210 may be a low-level 8-bit microprocessor or any other types of microprocessor capable of processing commands and responses. The processor 210 is the connection point of the apparatus to an external device, such as a medical device, and it controls the processing within the apparatus. The processor 210 may receive commands from the external device, such as a medical device, and transmit the commands to either the system memory 205 or the recognition engine 215. The processor 210 may also transmit signals to the LCD control 230, the digital-to-analog converter 240, or the pulse width modulator 245.

The recognition engine 215 may be implemented by use of a digital signal processing (DSP) unit or a mathematics coprocessor unit. The DSP or the mathematics coprocessor unit could compress and decompress the signals generated from a user's voice intonation, speech pattern, and/or emotions. In this way, the DSP or mathematics coprocessor unit may be used to identify and recognize audible requests, and can be used to generate and transmit visual or audible responses or instructions.

The system memory 205, which may include both RAM and ROM may have several purposes. First, it may store the software required for use with the processor 210 and/or the recognition engine 215. Second, it may store a constant representing the normal voice intonation, speech patterns and/or emotions of a user or the normal operations of a device. A third purpose of the system memory 205 may be to serve as a storage unit for signals that may be compressed by the recognition engine 215. A fourth purpose of the system memory 205 may be to store instructions for use during the instruction mode, and a fifth purpose may be to store reminder for use during the reminder mode.

The communications element 220 provides a link between the microprocessor and a designated recipient. The communications element 220 may be a USB, modem, or any type of connection for transmitting information to a designated recipient. For example, it may be an infrared connection or a serial/parallel cable connection, or any type of Internet connection.

The timer 225 records or provides the day, month, and year and is used by the processor 210 to control timing. For example, in the reminder mode, the user may want the apparatus to automatically provide him with a reminder note at a specific time, day and year. That feature is accomplished by use of the timer 225.

The LCD control 230, analog-to-digital converter 235, digital-to-analog converter 240, and the pulse width modulator 245 (PWM) serve as interfaces between the microprocessor and other devices. For example, the LCD control 230 is an interface between the processor 210 and a display device, such as an LCD. The analog-to-digital converter converts external analog signals from a user's voice intonation, speech patterns, or emotions to digital signals, for use by the processor 210. The digital-to-analog converter and the PWM operate together to convert digital signals from the processor 210 to analog signals.

In an alternative embodiment, apparatus 200 may be achieved by a simple software program which may convert an analog signal to a digital signal, process the digital signal, convert the digital signal to another analog signal, and output the second analog signal in accordance with the mode the apparatus is operating in. Those skilled in the art may also recognize other embodiments to implement the present invention.

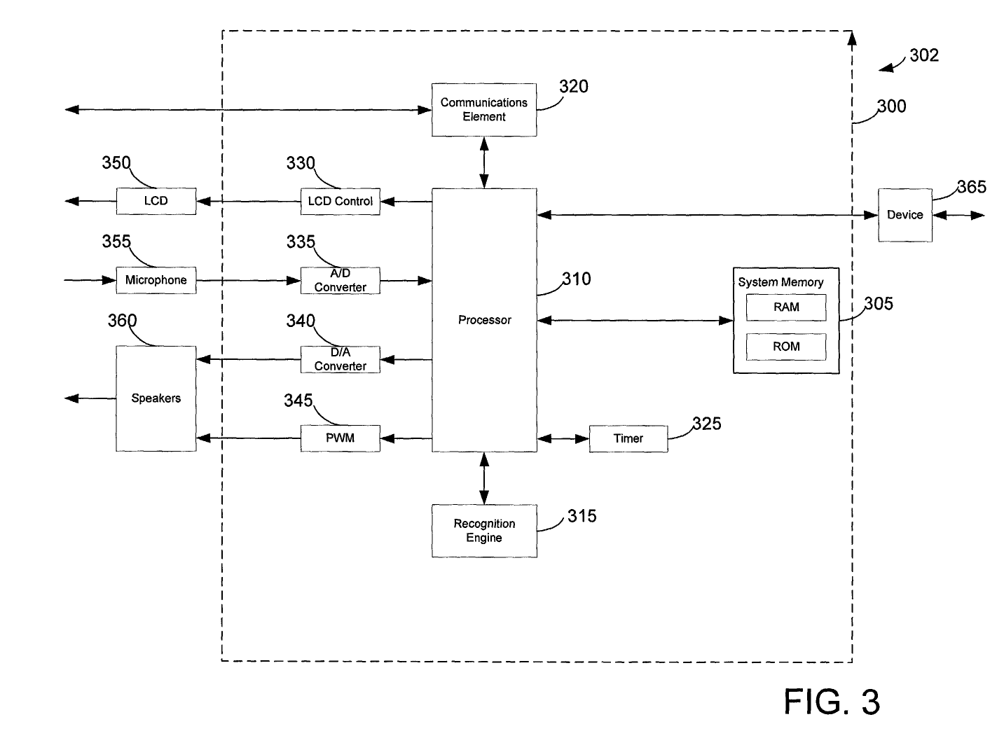

FIG. 3 shows a system 302 of the present invention, which includes the apparatus of FIG. 2. More specifically, FIG. 3 shows the apparatus 300 of the present invention connected to a device 365. The device 365 may be a medical device, a cellular telephone, or any other device that may benefit from a more humanistic operation. The apparatus 300 is also connected to an LCD 350 via an LCD control 330, a microphone 355 via an analog-to-digital converter 335, and speakers 360 via both a digital-to-analog converter 340 and a PWM 345. The LCD 350 may be replaced with any other type of display device, such as a computer screen. Likewise, the LCD control 330 can be replaced by any appropriate display control that is operative with the display device.

To illustrate the operation of the system 302, consider, for example, that the device 365 is a medical device for measuring liver capacity using the patient's glutamic oxalic transaminase (GOT) number. The user may use the microphone to request his GOT number, and according to the present invention, the analog-to-digital converter 335 will convert the voice command to a digital signal for use by the processor 310. The processor 310 may retrieve a stored GOT number from the system memory 305, or may take a reading from the device 365. The processor 310 would then transmit the digital reading to the LCD 350 for a visual display, or would convert the digital reading of the GOT number to an analog signal via the digital-to-analog converter 340 for an audio output via the speakers 360. In addition, the processor 310 may also transmit the digital signal, via the communications element 320, to a designated recipient, which may be a computer, insurance company, doctor's office, hospital, or other location, or a person.

The device 365 such as a telephone or cellular phone may have a built-in LCD, microphone, and/or speaker. The device 365 may also have a built-in LCD controller, analog-to-digital converters, and/or digital-to-analog converters. In such instances, a separate LCD, microphone, speaker, controller and/or converters would not be necessary.

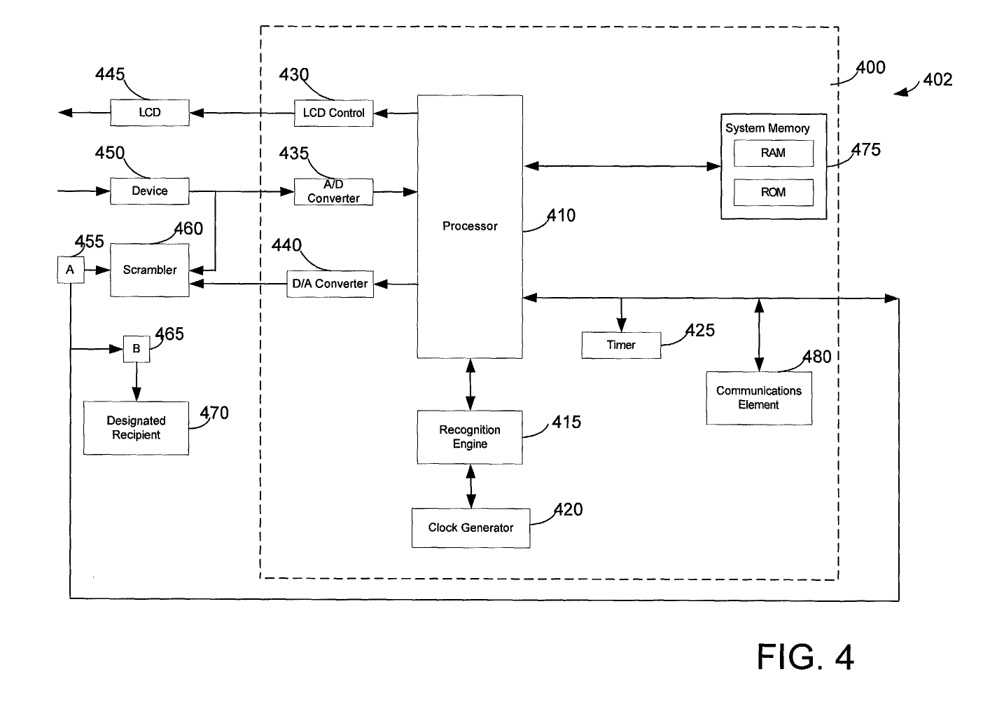

FIG. 4 shows a system 402 in the emergency mode of the present invention. As shown, system 402 includes an apparatus 400 connected to a designated recipient 470 and to a device 450, such as a cellular phone, having a microphone. The device may also be a medical device, a telephone, or any other device that may benefit from a more humanistic operation. A device without a built-in microphone may also benefit from the present invention. In this embodiment, the device 450 may be connected to the processor via analog-to-digital converter 435. The designated recipient 470 may be an emergency service such as the police station or a hospital. The apparatus 400 may also be connected to an LCD 445 via LCD control 430, a scrambler 460 via digital-to-analog converter 440, system memory 475, a timer 425, a communications element 480, a recognition engine 415, and a clock generator 420.

Using a cellular phone with a built-in microphone as an example, a cellular phone user may speak into the microphone of the device 450, and the microphone generates voice signals. The voice signals may be converted to digital signals and transmitted to the processor 410. The voice signals may also be transmitted to the scrambler 460. The recognition engine 415 may interpret the voice signals and transmit the interpreted voice signals to the processor 410. The processor 410 may also scan the system memory 475 to retrieve the constant generated in either the monitor mode, instruction mode, and/or reminder mode, and compare the constant to the voice signals. If after the comparison, the processor 410 detects a change in voice intonation, speech patterns, signal patterns, and/or emotions of a user, then the processor 410 automatically communicates to the designated recipient 470 the existence of an emergency situation.

In an alternative embodiment, a device 450 without a built-in microphone may also be utilized. For example, the device 450 may be a pacemaker. Using a pacemaker as an example of the device 450, the signals generated by the pacemaker may be transmitted to the analog-to-digital converter 435 and/or the scrambler 460. The processor 410 may scan the system memory 475 to retrieve the constant generated in the monitor mode, instruction mode, and/or reminder mode, and compare the constant to the heart beat signals. Alternatively, the processor 410 may compare the signals with a prestored heart beat signal provided by a pacemaker manufacturer, doctor, or the like. In case of emergency, the variations in signal patterns will trigger the emergency mode, and a designated recipient 470 may be notified.

In yet another embodiment, a microphone may be built into an apparatus 400 designed in accordance with the present invention. Such microphone would allow a device 470 without a microphone to work with the present invention as well.

The circuitry of the present invention may also include a clock generator 420. This clock generator may have a power save function, and the control circuitry of the clock generator can be divided into three parts. The first part is a phase-locked loop (PLL) or a delay-locked loop (DLL). The second part is an oscillator that can be used to control the timer and the PLL or DLL, or the microprocessor. The third part is the clock control. The clock control switches back and forth between the oscillator and the PLL/DLL mode in response commands issued by the microprocessor.

There are three modes of operation for the clock generator. In the first mode, both the oscillator and the PLL or DLL loop can generate a clock signal. In this mode, the system is at full power. For example, both the apparatus and the device, such as a cell phone, are on. The second mode of operation for the clock generator occurs when the microprocessor shuts down the entire clock generator. Accordingly, both the oscillator and the PLL/DLL loop are shut down. In the second mode, the entire system design, in accordance with the present invention, is shut down. That is to say, for example, both the apparatus and the cell phone are off. In the third mode, the microprocessor only shuts down the PLL or DLL loop. In this mode, only the timer and the oscillator are consuming power. Therefore, the power consumption in the third mode is very small. The timer or the input port trigger can trigger the PLL or DLL loop, bringing the system, including the cell phone, back into normal operation.

In the emergency mode of operation, the device, such as a cellular phone, can be either on or off. If the device, is off when the processor 410 detects the abnormal conditions, the processor 410 may trigger the clock generator 420.

In the emergency mode, the voltage goes high at the voltage node B 465, and the designated recipient 470 receives notification of the emergency. Also, at the voltage node A 455, a connection is made so as to provide further information to the designated recipient 470. As such, the designated recipient 470 would have access to information stored in the system memory 475 for use during an emergency. For example, consider the emergency mode working in conjunction with the reminder mode. In the reminder mode of operation, the user may pre-record messages such as, “In case of emergency, I am allergic to penicillin.” The reminder is stored in system memory 480. The reminder mode would receive a trigger to automatically provide the reminder when an emergency arises.

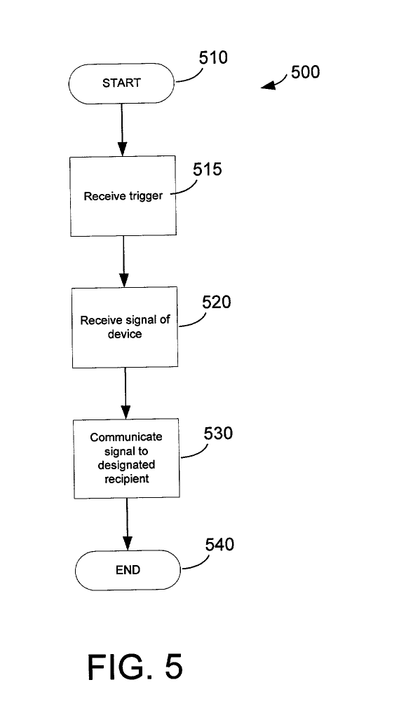

FIG. 5 shows one method of implementing the monitor mode of operation. Referring to FIG. 5, the method 500 begins at start step 510 and proceeds to step 515 when the preferred application program module receives a trigger. The trigger is an indication to the preferred application program module to begin the method 500. Preferably, the trigger is generated when the user activates the monitor mode. For example, the user may activate the monitor mode by selecting a monitor mode of operation while the apparatus is turned on, or if the monitor mode is the only mode of operation for the apparatus, the trigger may be generated when the apparatus is turned on. This step may be omitted. For example, if the device such as a pacemaker is always on, the apparatus may always be on, and this step would not be necessary. After the preferred application program module receives the trigger at step 515, the apparatus receives signals, which are output from the device at step 520. Next, the method proceeds to step 530. At step 530, the apparatus transmits the signals to the designated recipient. The designated recipient may be the user, a nurse, a hospital, a doctor, a computer or the like. Once all of the steps are completed, the method 500 ends at step 540. Method 500 may repeat itself until the monitor mode is deactivated or until other modes are activated.

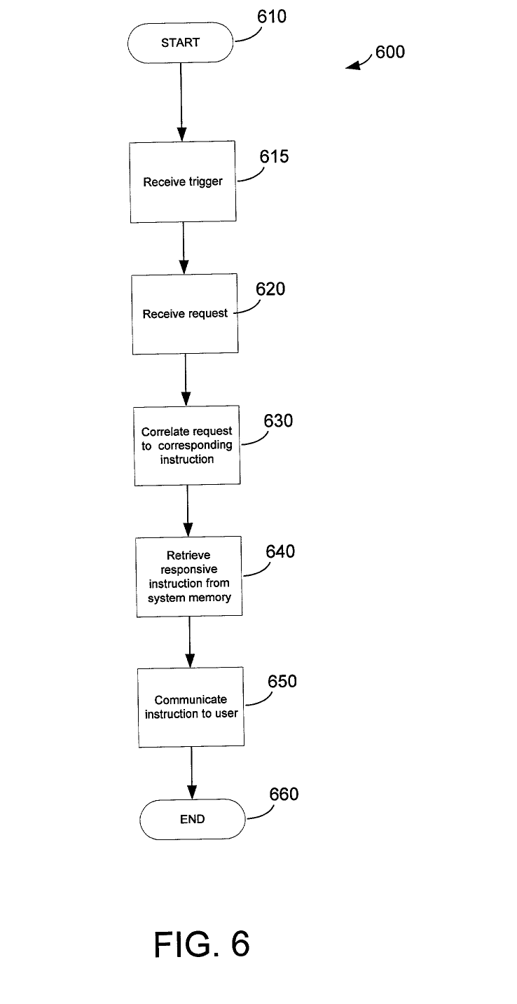

FIG. 6 shows one method of implementing the instruction mode of operation. As shown in FIG. 6, method 600 begins at start step 610 and proceeds to step 615 when the preferred application program module receives a trigger. The trigger is an indication to the preferred application program module to begin the method 600. Preferably, the trigger is generated when the user activates the instruction mode. For example, the user may activate the instruction mode by selecting the instruction mode of operation while the apparatus is turned on, or if the instruction mode is the only mode of operation for the apparatus, the trigger may be generated when the apparatus is turned on. As discussed above, this step may be omitted depending on the design and usage of the device. After the preferred application program module receives the trigger at step 615, the apparatus receives a request at step 620. The request may be a user request such as a verbal command, an input command, or the like. The request may also be a pre-scheduled event. For example, when a device is used for the first time, a signal constituting a request may be sent to the apparatus. Next, the method 600 proceeds to step 630. At step 630, the apparatus correlates the user request to a corresponding instruction. Next, the apparatus retrieves the responsive instruction from the system memory in step 640 and communicates the instruction to the user in step 650. Once all of the steps are completed, the method 600 ends at step 660. Method 600 may repeat itself until the instruction mode is deactivated or until other modes are activated or until overridden by another mode of operation.

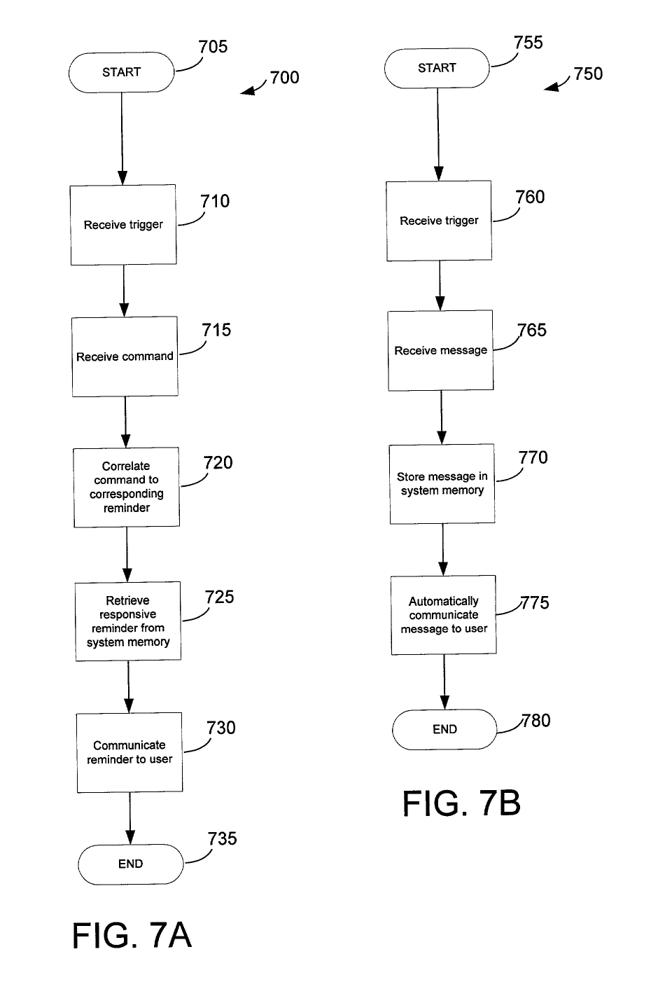

FIG. 7 illustrates methods of implementing the reminder mode of operation. FIG. 7A shows one way of providing automatic reminders to a user in response to the user's command. As shown in FIG. 7A, the method 700 begins at start step 705 and proceeds to step 710 when the preferred application program module receives a trigger. The trigger is an indication to the preferred application program module to begin the method 700. Preferably, the trigger is generated when the user activates the reminder mode. For example, the user may activate the reminder mode by selecting a reminder mode of operation while the apparatus is turned on, or if the reminder mode is the only mode of operation for the apparatus, the trigger may be generated when the apparatus is turned on. Again, this step may be omitted. After the preferred application program module receives the trigger at step 710, the apparatus receives the user's command, such as “Remind me to take my medicine at 9:00 am.” Next, the method proceeds to step 720. At step 720, the apparatus correlates the user's command to a corresponding reminder, which is stored in the system memory. After the apparatus retrieves the reminder from the system memory in step 725, the apparatus communicates the reminder to the user at step 730. Once these steps are completed, the method 700 ends at step 735. Method 700 may repeat itself until the reminder mode is deactivated or until overridden by another mode of operation.

FIG. 7B illustrates one method for recording messages and automatically providing those messages to the user under certain specified conditions. As shown in FIG. 7B, the method 750 begins at start step 755 and proceeds to step 760 when the preferred application program module receives a trigger. The trigger is an indication to the preferred application program module to begin the method 750. Preferably, the trigger is generated when the user activates the reminder mode. This step again may be omitted. After the preferred application program module receives the trigger at step 760, the apparatus receives a message in step 765. To illustrate, a person may input a message into the apparatus such as, “Keep up the good work.” The apparatus receives this message in step 765, and in step 770, the apparatus stores the message in system memory. Next, the method proceeds to step 775. At step 775, the apparatus automatically communicates the message to the user. The message may be communicated at a certain time of a day. Once these steps are completed, the method 750 ends at step 780. Method 750 may repeat itself until the reminder mode is deactivated or until overridden by another mode of operation.

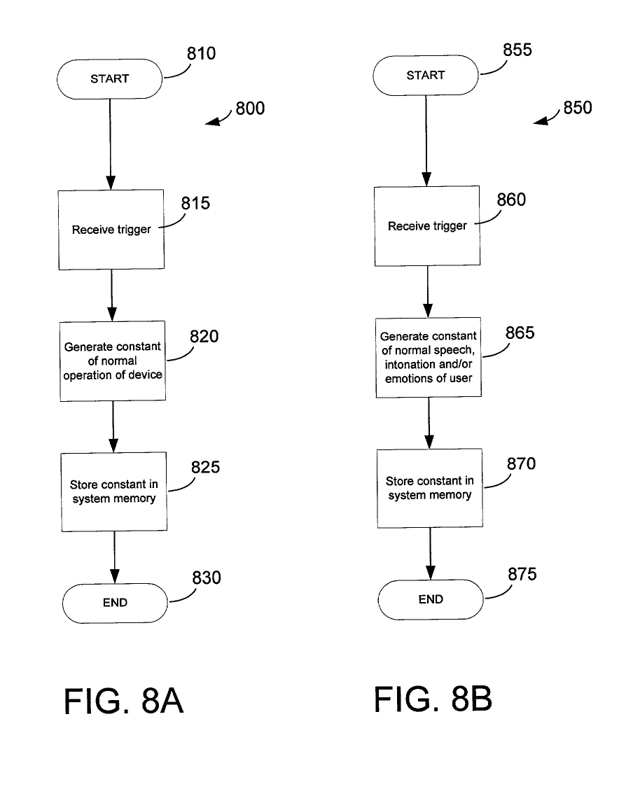

In the monitor mode, the instruction mode, and reminder mode, the apparatus can be configured to generate constants representing normal conditions. The flowcharts in FIG. 8 show methods of generating these constants, which are used in the emergency mode of operation to detect emergency conditions. Because these constants are used only in the emergency mode, the apparatus does not have to be configured to generate these constants if the apparatus does not include an emergency mode of operation.

FIG. 8A shows a method for generating a constant that represents the normal conditions of a device. The method 800 begins at start step 810 and proceeds to step 815 when the preferred application program module receives a trigger. The trigger is an indication to the preferred application program module to begin the method 800. The trigger may be generated when the user turns on the device. In the alternative, there may be a separate mode of operation, specifically designed for the detection of normal conditions of the device. As such, the trigger may be generated when the user activates a constant detection mode. Again, this step may be omitted. After the preferred application program module receives the trigger at step 815, the apparatus generates a constant of normal operation of the device in step 820. The constant may represent the speech patterns, signal patterns, emotion patterns, intonations, facial expressions, or the like. In step 825, the apparatus stores the constant in system memory. Next, the method 800 ends at step 830. Method 800 may be a one-time process to determine the normal operation of the device. However, the method 800 may also be repeated to adjust the constant if the normal operation of the device changes.

FIG. 8B shows a method for generating a constant that represents the normal conditions relating to voice intonations, speech, and/or emotions of a user. The method 850 begins at start step 855 and proceeds to step 860 when the preferred application program module receives a trigger. The trigger is an indication to the preferred application program module to begin the method 855. The trigger may be generated when the user turns on the device. In the alternative, there may be a separate mode of operation, specifically designed for the detection of normal conditions relating to voice intonations, speech, and/or emotions of a user. As such, the trigger may be generated when the user activates a constant detection mode. This step, however, may be omitted depending upon the design of the system. After the preferred application program module receives the trigger at step 860, the apparatus generates a constant of the normal voice intonations, speech, and/or emotions of the user in step 865. The constant may be represented as a wave signal or it may be a numeric representation or the like. In step 870, the apparatus stores the constant in system memory. Next, the method 800 ends at step 875. Method 850 may be a one-time process to determine the normal voice intonations, speech, and/or emotions of the user. However, the method 850 may be repeated to adjust the constant if the user's voice intonations, speech, and/or emotions should change.

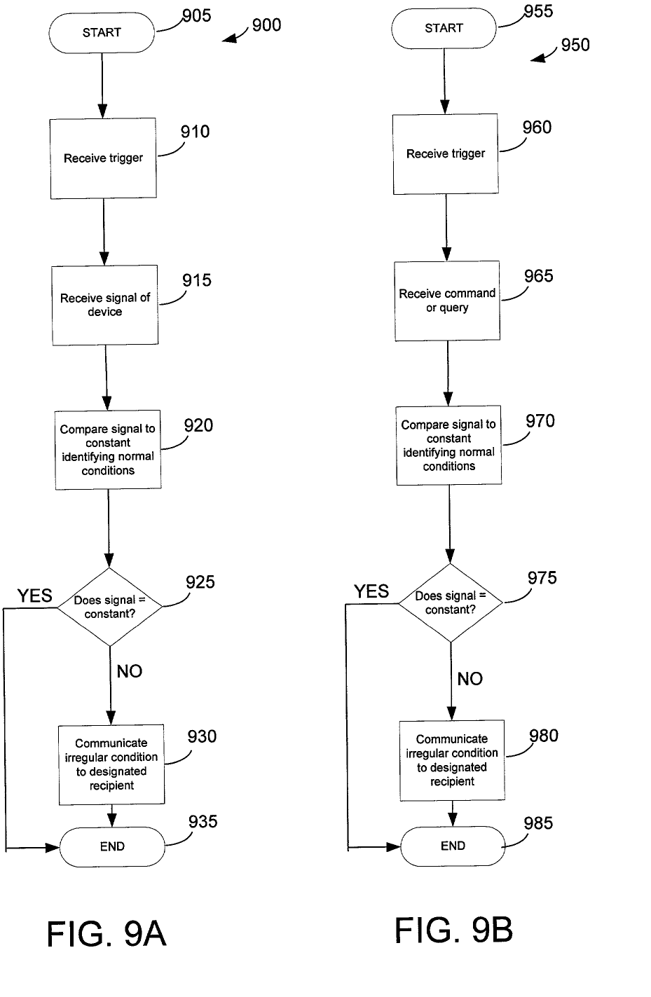

FIG. 9 illustrates one method of implementing the emergency mode of operation. FIG. 9A shows one method of detecting emergency conditions with regard to the operation of the device. The method 900 begins at start step 905 and proceeds to step 910 when the preferred application program module receives a trigger. The trigger is an indication to the preferred application program module to begin the method 900. Preferably, the trigger is generated when the user activates the emergency mode. For example, the user may activate the emergency mode by selecting the emergency mode of operation while the apparatus is turned on. It should be noted, however, that the device itself does not have to be on for the emergency mode to operate. Therefore, the device can be off, and the apparatus can generate the trigger when the user activates the emergency mode. That is to say, the activation of the emergency mode is independent of the activation of the device.

The user may also activate the emergency mode via specified commands. For example, the user may say, “emergency.” The trigger may also be activated by other modes of the operation. For example, if a deviation from the norm is detected in the monitor mode, a trigger to activate the emergency mode may be sent by the processor. Step 910, again, may be omitted depending on the design and operation of the system.

After the preferred application program module receives the trigger at step 910, the apparatus receives signals from the device in step 915. In step 920, the apparatus compares the signals to a constant for identifying normal conditions of the device, which was generated in method 800. At decision step 925, a determination is made as to whether the data signal received in step 915 is equal to or within a permissible range of the constant. If the data signal is equal to or within a permissible range of the constant, then the method 900 ends at step 935, and method 900 repeats itself until the emergency mode is deactivated. However, if the data signal does not equal to or is not within a permissible range of the constant, then method 900 proceeds to step 930 to communicate the irregular condition to a designated recipient. After step 930, method 900 ends at step 935.

FIG. 9B shows one method of detecting emergency conditions with regard to a user's voice intonations, speech, and/or emotions. The method 950 begins at start step 955 and proceeds to step 960 when the preferred application program module receives a trigger. The trigger is an indication to the preferred application program module to begin the method 900. Preferably, the trigger is generated when the user activates the emergency mode. For example, the user may activate the emergency mode by selecting the emergency mode of operation while the apparatus is turned on. However, the device itself does not have to be on for the emergency mode to operate. Therefore, the device can be off, and the apparatus can generate the trigger when the user activates the emergency mode. That is to say, the activation of the emergency mode is independent of the activation of the device. This step again may be omitted. After the preferred application program module receives the trigger at step 960, the apparatus receives voice signals input into the device by the user in step 965. In step 970, the apparatus compares the voice signals to the constant for identifying normal voice intonations, speech, and/or emotions of the user, which was generated in method 850. At decision step 975, a determination is made as to whether the voice signal received in step 965 is equal to or within a permissible range of the constant. If the data signal is equal to or within a permissible range of the constant, then the method 950 ends at step 985, and method 900 repeats itself until the emergency mode is deactivated. Otherwise, if the data signal does not equal to or is not within a permissible range of the constant, then method 950 proceeds to step 980 to communicate the irregular condition to a designated recipient. After step 980, method 950 ends at step 985.

In yet another method of determining emergency conditions, steps 920 and 970 may be replaced with comparing the signals with a pre-defined set of conditions. For example, the pre-defined conditions may be a list of words or phrases such as “emergency,” “help,” “call 911,” identifying the emergency. The pre-defined condition may be a threshold level of a condition such as battery power, which can identify a device on the crust of power failure. In this example, each of steps 925 and 975 may be replaced with the step of determining whether the conditions are met so as to determine whether it is necessary to contact a designated recipient in steps 930 and 980.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. An apparatus operable in at least one of a plurality of operating modes, the apparatus comprising:
a recognition engine;
a system memory; and
a processor programmed to:
receive data signals of a device and transmit the data signals to a designated recipient, when the apparatus is in a first operating mode; and
receive a command of a user, transmit the command to the recognition engine for interpretation of the command, receive the interpreted command from the recognition engine, scan the system memory for a response responsive to the interpreted command, and transmit the response to the user, when the apparatus is in a second operating mode.

2. An apparatus operable in at least one of a plurality of operating modes, the apparatus comprising:
a recognition engine;
a system memory;
a processor programmed to:
receive data signals of a device and transmit the data signals to a designated recipient, when the apparatus is in a first operating mode; and
receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

3. The apparatus of claim 2, the processor being programmed further to transmit the reminder at a specified time.

4. The apparatus of claim 2, the processor being programmed further to transmit the reminder upon reaching a specified condition.

5. An apparatus operable in at least one of a plurality of operating modes, the apparatus comprising:
a recognition engine;
a system memory; and
a processor programmed to:
receive a command of a user, transmit the command to the recognition engine for interpretation of the command, receive the interpreted command from the recognition engine, scan the system memory for a response responsive to the interpreted command, and transmit the response to the user, when the apparatus is in a first operating mode; and
receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

6. The apparatus of claim 5, the processor being programmed further to transmit the reminder at a specified time.

7. The apparatus of claim 5, the processor being programmed further to transmit the reminder upon reaching a specified condition.

8. An apparatus operable in at least one of a plurality of operating modes, the apparatus comprising:
a recognition engine;
a system memory;
a processor programmed to:
receive data signals of a device and transmit the data signals to a designated recipient, when the apparatus is in a first operating mode;
receive a command of a user, transmit the command to the recognition engine for interpretation of the command, receive the interpreted command from the recognition engine, scan the system memory for a response responsive to the interpreted command, and transmit the response to the user, when the apparatus is in a second operating mode;
receive a request for a reminder, transmit the request to the recognition engine for interpretation of the request, receive the interpreted request from the recognition engine, store the interpreted request in the system memory, and transmit the reminder corresponding to the request, when the apparatus is in a third operating mode; and
detect abnormal conditions and communicate the presence of the abnormal conditions to a designated recipient, when the apparatus is in a fourth operating mode.

9. The apparatus of claim 8, wherein the processor is further programmed to generate a constant representing normal conditions, when the apparatus is in the first, second, and third operating modes.

10. The apparatus of claim 9, wherein the processor detects the abnormal conditions by comparing the constant representing normal conditions to data signals of the device.

11. The apparatus of claim 8, wherein the processor detects the abnormal conditions by comparing data signals of the device to a pre-determined condition.

12. An apparatus operable in at least one of a plurality of operating modes, the apparatus comprising:
a recognition engine;
a system memory;
a processor programmed to:
receive data signals of a device and transmit the data signals to a designated recipient, when the apparatus is in a first operating mode;
receive a command of a user, transmit the command to the recognition engine for interpretation of the command, receive the interpreted command from the recognition engine, scan the system memory for a response responsive to the interpreted command, and transmit the response to the user, when the apparatus is in a second operating mode; and
receive a request for a reminder, transmit the request to the recognition engine for interpretation of the request, receive the interpreted request from the recognition engine, store the interpreted request in the system memory, and transmit the reminder corresponding to the request, when the apparatus is in a second operating mode.

13. A method for communicating with a device in a system, wherein the system is operable in a plurality of operating modes, the method comprising:
receiving data signals of the device and transmitting the data signals to a designated recipient, when the system is in a first operating mode;
receiving a command of a user, transmitting the command to a recognition engine for interpretation of the command, receiving the interpreted command from the recognition engine, scanning a system memory for a response responsive to the interpreted command, and transmitting the response to the user, when the system is in a second operating mode;
receiving a request for a reminder, transmitting the request to the recognition engine for interpretation of the request, receiving the interpreted request from the recognition engine, storing the interpreted request in the system memory, and transmitting the reminder corresponding to the request, when the system is in a third operating mode; and
detecting abnormal conditions and communicating the presence of the abnormal conditions to a designated recipient, when the system is in a fourth operating mode.

14. A system operable in at least one of a plurality of operating modes, comprising:
means for receiving data signals of the device and transmitting the data signals to a designated recipient, when the system is in a first operating mode;
means for receiving a command of a user, transmitting the command to a recognition engine for interpretation of the command, receiving the interpreted command from the recognition engine, scanning a system memory for a response responsive to the interpreted command, and transmitting the response to the user, when the system is in a second operating mode;
means for receiving a request for a reminder, transmitting the request to the recognition engine for interpretation of the request, receiving the interpreted request from the recognition engine, storing the interpreted request in the system memory, and transmitting the reminder corresponding to the request, when the system is in a third operating mode; and
means for detecting abnormal conditions and communicating the presence of the abnormal conditions to a designated recipient, when the system is in a fourth operating mode.
